(19) United States
(12) Patent Application Publication
(10) Pub. No.: US 2023/0148621 A1
(43) Pub. Date: May 18, 2023

(54) METHOD FOR PROCESSING DRIED-TANGERINE-PEEL QINGZHUAN TEA

(71) Applicant: Institute of Fruit & Tea, Hubei Academy of Agricultural Sciences, Wuhan (CN)

(72) Inventors: Xun CHEN, Wuhan (CN); Xian ZHANG, Wuhan (CN); Gaixiang LEI, Wuhan (CN); Wenli ZHANG, Wuhan (CN)

(73) Assignee: Institute of Fruit & Tea, Hubei Academy of Agricultural Sciences, Wuhan (CN)

(21) Appl. No.: 18/156,090

(22) Filed: Jan. 18, 2023

(30) Foreign Application Priority Data
Aug. 23, 2021 (CN) 2021109707696

(51) Int. Cl. A23F 3/14; A23F 3/32; B65B 29/02

(52) U.S. Cl. CPC A23F 3/14; A23F 3/32; B65B 29/02

(57) ABSTRACT

The present disclosure relates to the technical field of tea processing, and discloses a method for processing dried-tangerine-peel Qingzhuan tea, including: weighing tea raw materials accurately according to a weight of a dried-tangerine-peel green tea brick; mixing raw material tea leaves and dried tangerine peels evenly, and steaming a mixture with a steamer; pressing the mixture into a tea-brick mold, covering with an aluminum cover plate and a corner iron fin immediately, and pressing compactly under a pressure machine; cooling to shape a pressed tea brick, and then removing the tea brick that is cooled and shaped; feeding the removed tea bricks to a drying room, arranging the tea bricks orderly on a drying rack at regular intervals for drying treatment, stop heating after the drying treatment is finished, opening a window for cooling, taking the tea bricks out of the dry room, and then packaging.

### CROSS-REFERENCE TO RELATED APPLICATIONS

The application claims priority to Chinese patent application No. 2021109707696, filed on Aug. 23, 2021, the entire contents of which are incorporated herein by reference.

### TECHNICAL FIELD

The present disclosure relates to the technical field of tea production and processing, and more particularly, to a method for processing dried-tangerine-peel Qingzhuan tea.

### BACKGROUND

With the rapid social and economic development of China, the standard of living is now higher than ever, and the dietary structure of people has drastically changed. A part of the population is reduced to a sub-health state due to high fat, high protein, and high sugar intake, in addition to adverse environmental factors, an increasingly accelerated pace of life, and a heavier workload. So far, there have been more patients than ever with cardiovascular and cerebrovascular diseases and more cases of sub-health concerning the metabolism and immune system, which indicates that human health has been seriously affected. Although health-care tea products for these symptoms are plenty in the market, they are not suitable for long-term drinking in all seasons because of their deficiencies in formula composition and efficacy, and there is a blank in the market to be filled up with post-fermented Qingzhuan tea and dried-tangerine-peel Qingzhuan tea taking dried tangerine peels as the main formula. Therefore, a new method for processing dried-tangerine-peel Qingzhuan tea is desirable.

The Qingzhuan tea originating in Hubei province is beneficial to digestion, decomposing fat, relaxing intestines and stomach, anti-oxidation, lowering blood sugar, sterilization, and antidiarrheal, and has already become an indispensable necessity in the daily life of Chinese border minority people and foreign tea lovers. Currently, efforts are being made to develop a new product of Qingzhuan tea, reorient the product to new markets and audiences, and give full play to the functional advantages of Qingzhuan tea with the dubiously oriented old mode of sale abandoned. Specifically, the new product of brick tea, with auxiliary curative effect and health care function, will target the elderly and those with hypertension, hyperlipidemia, and hyperglycemia, so as to meet the special needs of special groups.

There is an old saying “it takes a thousand years to grow ginseng, and a hundred years to produce dried tangerine peels.” Dried tangerine peels are warm in nature and taste bitter and pungent, usually used for regulating vital energy, eliminating phlegm, strengthening the spleen, and removing dampness. Dried tangerine peels are often used for cooking and flavoring, and at the same time for brewing a tea beverage. However, the dried-tangerine-peel beverage is not suitable for long-term drinking because the dried tangerine peels taste poor when brewed alone. Qingzhuan tea has a slightly bitter and stale taste after fermentation, which is not acceptable for many people, especially kids and the youth. Therefore, to improve the taste and flavor of Qingzhuan tea, some traditional Chinese herbals such as dried tangerine peels are generally added into Qingzhuan tea, which, in the meantime of improving and enriching the taste of Qingzhuan tea, improves the medical efficacy.

Dried-tangerine-peel tea is currently marketed as dried-tangerine-peel green tea, dried-tangerine-peel Pu'er tea, and dried-tangerine-peel Qingzhuan tea, and has a mixed aroma of tea and dried tangerine peels, gradually becoming a beloved beverage. The dried-tangerine-peel tea is generally made by cutting the aged and dried tangerine peels into pieces and mixing the same with Pu'er tea leaves (or fermented Pu'er tea leaves), pressing a mixture into a desired shape, and then fermenting to prepare dried-tangerine-peel Pu'er tea with good taste and aroma. However, this processing method has some disadvantages, that is, in the process of compacting the dried-tangerine-peel Pu'er tea into a final product (such as tea brick or caked tea, a bowl-shaped compressed mass of tea leaves), due to the expansion and contraction of dried tangerine peels and tea leaves themselves, the bonding between dried tangerine peels and tea leaves is not uniform, or the compacted tea products is poorly shaped; after being in storage for a period of time, the tea brick is likely to crack, fall apart, and even mildew. Therefore, developing a method for processing dried-tangerine-peel Qingzhuan tea becomes a problem to be solved urgently for those skilled in the art, and is of great significance to further improve and enhance the efficacy and quality of Qingzhuan tea.

### SUMMARY

In view of the problems of the prior art, it is an object of the present disclosure to provide a method for processing dried-tangerine-peel Qingzhuan tea.

The object is achieved through the following technical solution. A method for processing dried-tangerine-peel Qingzhuan tea, comprising steps of:

step 1, weighing tea raw materials: weighing tea raw materials accurately according to a weight of a dried-tangerine-peel green tea brick;

step 2, steaming: mixing raw material tea leaves and dried tangerine peels evenly, and steaming a mixture with a steamer;

step 3, molding and pressing: pressing the mixture into a tea-brick mold, covering with an aluminum cover plate and a corner iron fin immediately, and pressing compactly to shape the mixture under a pressure machine;

step 4, cooling to shape and removing tea bricks: cooling to shape a pressed tea brick, and then removing the tea brick that is cooled and shaped;

step 5, drying: feeding the removed tea bricks to a drying room, arranging the tea bricks orderly on a drying rack at regular intervals for drying treatment, stopping heating after the drying treatment is finished, opening a window for cooling, taking the tea bricks out of the dry room, and then packaging; and

step 6, checking and packaging the tea bricks: packaging the tea bricks that are qualified as the dried-tangerine-peel Qingzhuan tea piece by piece with trademarked packaging paper, and putting a finished product into storage.

Further, in step 1, dark primary tea leaves with better tenderness are taken as a raw material of the brick tea, and finer dried-tangerine-peel Qingzhuan tea is made by mixing and pressing third-grade dark primary tea leaves and dried tangerine peels, where a ratio of the dried tangerine peels to the Qingzhuan tea is 1:7.

Further, in step 2, the raw material tea leaves are uniform and complete, scented, and refreshing, without mildew or any artificial color in appearance, any flavoring agent, any deterioration, or any peculiar smell; in terms of inherent qualities, the raw material tea leaves can be brewed to release an intense and lasting aroma; the brewed tea leaves are a even mixture of both fresh and aged ones: tea dregs show uniform glosses; the tea is clear in a yellowish green color, with few tea dregs, ash content≤9.0%, and moisture>10.0%.

Further, in step 2, the tangerine peels are obtained through a natural sunning method, have a faint and non-pungent smell, and release a mellow aroma unique to tangerine peels; a surface of the tangerine peels looks in dark brown, has a thin skin, and is lightweight and easy to be bent; further, the surface of dried tangerine peels has a delicate fragrance, is in an orange or reddish brown color, and is featured by fine wrinkles and depressed punctiform oil cavities; the surface is yellow-white, rough and spongy, has a yellow-white or yellow-brown vein-like vascular bundle, and is slightly hard and crisp, with an intense and bitter flavor.

Further, in step 2, the steaming is conducted at a temperature of 98-102° C. for 50 seconds to wet and soften the tea leaves.

Further, in step 4, the cooling comprises lowering a temperature of the tea bricks from 80° C. to 50° C. in a duration of 80 minutes.

Further, in step 5, the drying treatment comprises 5 to 7 days for drying, and preferably 7 to 10 days in total, where a temperature is kept at 45° C., and a relative humidity is kept at 50%.

Further, in step 5, an inner packaging material meets a standard for edible products, and an outer packaging material is clean and sanitary and can be clean cartons.

Further, in step 6, it is required that a storage environment shall be:

kept dry, ventilated, and clean, provided with facilities for preventing poison, rats and pests, equipped with ultraviolet disinfection facilities in a warehouse for inner pack-aging materials, so as to ensure the storage is kept in a dry, ventilated and clean environment.

Further, in step 6, it is further required for the storage environment that:

a stack shall have a thickness of more than 30 cm from a wall and a distance of not less than 15 cm from a ground, and it is not allowed to store any articles, sundries or contaminated food which may undermine food hygiene.

The advantages and positive effects of the present disclosure are apparent from the technical solutions described above and are set forth below.

(1) According to the present disclosure, the method for processing dried-tangerine-peel Qingzhuan tea enhances the bonding between dried tangerine peels and tea leaves, and the resultant dried-tangerine-peel green tea brick has smooth and flat surfaces, regular edges and corners, a uniform thickness, and a clear impression texture, without such infectious microbe and deterioration as black, white, green, or red mildew inside the brick.

(2) According to the present disclosure, a product produced through the method herein has an excellent and stable quality, is cyan and brown in color, has rich nutrition, and can be in storage for long. Furthermore, it is convenient to carry the product, and steps of soaking the product in water for brewing are simple and quick. In addition, the product is endurable with a constant color and taste of the tea even after 10 rounds of brewing.

(3) According to the present disclosure, the dried-tangerine-peel Qingzhuan tea product processed through the method herein has an improved and enriched taste; furthermore, the health-care effect and flavor of the Qingzhuan tea is improved, which renders health-care effects of protecting the gastrointestinal tract, clearing the intestines, protecting the liver, relieving hyperglycemia and hyperlipidemia, and losing weight, suitable for long-term drinking.

### BRIEF DESCRIPTION OF DRAWINGS

To illustrate the technical solution of the embodiments of the present disclosure more clearly, a brief description is given below of the drawings that are necessary for the embodiments of the present disclosure. Apparently, the drawings described below are only some, but not all, embodiments of the present disclosure, and those of ordinary skill in the art can obtain other drawings based on drawings herein without paying any inventive effort.

FIG. 1 is a flowchart of a method for processing dried-tangerine-peel Qingzhuan tea according to an embodiment of the present disclosure.

FIG. 2 is a schematic diagram showing a mechanism of the method for processing dried-tangerine-peel Qingzhuan tea according to an embodiment of the present disclosure.

### DETAILED DESCRIPTION OF THE EMBODIMENTS

In order that the objects, aspects and advantages of the present disclosure will become more apparent, a detailed description of the disclosure will be rendered by reference to specific embodiments thereof. It should be understood that the embodiments described herein are illustrative only and are not limiting.

In view of the problems in the prior art, the present disclosure provides a method for processing dried-tangerine-peel Qingzhuan tea, and the present disclosure will be described in detail with reference to the accompanying drawings.

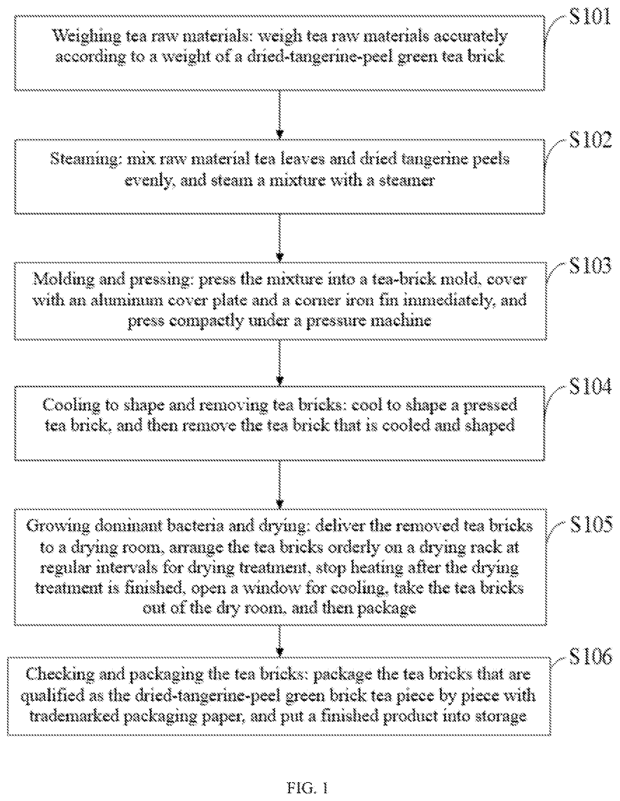

As shown in FIG. 1, an embodiment of the present disclosure provides a method for processing dried-tangerine-peel Qingzhuan tea, including steps of:

step 101, weighing tea raw materials: weighing tea raw materials accurately according to a weight of a dried-tangerine-peel green tea brick:

step 102, steaming: mixing raw material tea leaves and dried tangerine peels evenly, and steaming a mixture with a steamer;

step 103, molding and pressing: pressing the mixture into a tea-brick mold, covering with an aluminum cover plate and a corner iron fin immediately, and pressing compactly under a pressure machine:

step 104, cooling to shape and removing tea bricks: cooling to shape a pressed tea brick, and then removing the tea brick that is cooled and shaped;

step 105, drying: feeding the removed tea bricks to a drying room, arranging the tea bricks orderly on a drying rack at regular intervals for drying treatment, stopping heating after the drying treatment is finished, opening a window for cooling, taking the tea bricks out of the dry room, and then packaging: and

step 106, checking and packaging the tea bricks: packaging the tea bricks that are qualified as the dried-tangerine-peel Qingzhuan tea piece by piece with trademarked packaging paper, and putting a finished product into storage.

The embodiments of the present disclosure will be further described with reference to the following examples.

### Example 1: Description of the Dried-Tangerine-Peel Brick Tea Product

1. Description of Raw Materials or Category of Raw Materials

Raw material name: primary tea.

Characteristics: uniform leaves, faint fragrance, fresh flavor, mellow taste with sweetness, no mildew, no deterioration, and no peculiar smell.

Origin: Chibi County, Xianning City of Hubei Province;

Production method: primary processing;

Packaging: tea bags;

Storage environment: the storage environment is supposed to be kept dry, ventilated, and clean, and provided with facilities for preventing poison, rats and pests; a stack shall have a thickness of more than 30 cm from a wall and a distance of not less than 15 cm from a ground, and it is not allowed to store any articles, sundries or contaminated food which may undermine food hygiene;

Shelf life: this tea can be stored in a dry, ventilated, and clean environment for a long time;

Major product characteristics of primary tea tablets:

Appearance: no artificial color, flavoring agent, deterioration, or peculiar smell

Inherent quality: the tea leaves can be brewed to release an intense and lasting aroma; the brewed tea leaves are a even mixture of both fresh and aged ones; tea dregs show uniform glosses; the tea is clear in a yellowish green color, with few tea dregs.

Ash content: ≤9.0%

Moisture content: >10.0% A lower-grade primary tea is preferable.

Pre-production treatment: fermentation

Raw material name: dried tangerine peels

The tangerine peels are obtained through a natural sunning method, have a faint and non-pungent smell, and release a mellow aroma unique to tangerine peels.

A surface of the tangerine peels looks in dark brown, has a thin skin, and is lightweight and easy to be bent; further, the surface of dried tangerine peels has a delicate fragrance, is in an orange or reddish brown color, and is featured by fine wrinkles and depressed punctiform oil cavities.

The surface is yellow-white, rough, and spongy, has a yellow-white or yellow-brown vein-like vascular bundle, and is slightly hard and crisp, with an intense and bitter flavor.

2. Description of the Finished Product

Producer: Chibi Zhaoliqiao Tafeng Tea Industry Co. Ltd.

Address: No. 122, Yingbin Avenue, Chibi County. Hubei Province

Product category: tea leaf

Product name: Dried-tangerine-peel Qingzhuan tea

Main raw material and auxiliary ingredients: primary tea, and dried tangerine peels

Raw material origin: Xianning City area of Hubei Province; Xinhui District and other areas of Guangdong Province.

3. Description of Auxiliary Ingredient

Auxiliary ingredient name: inner and outer packaging materials;

Quality requirement: an inner packaging material shall meet a standard for edible products, and an outer packaging material shall be clean and sanitary;

Packaging requirement: clean carton package;

Storage requirement: the storage environment shall be kept dry, ventilated, and clean, provided with facilities for preventing poison, rats and pests, equipped with ultraviolet disinfection facilities in a warehouse for inner packaging materials

### Example 2: Process Flow

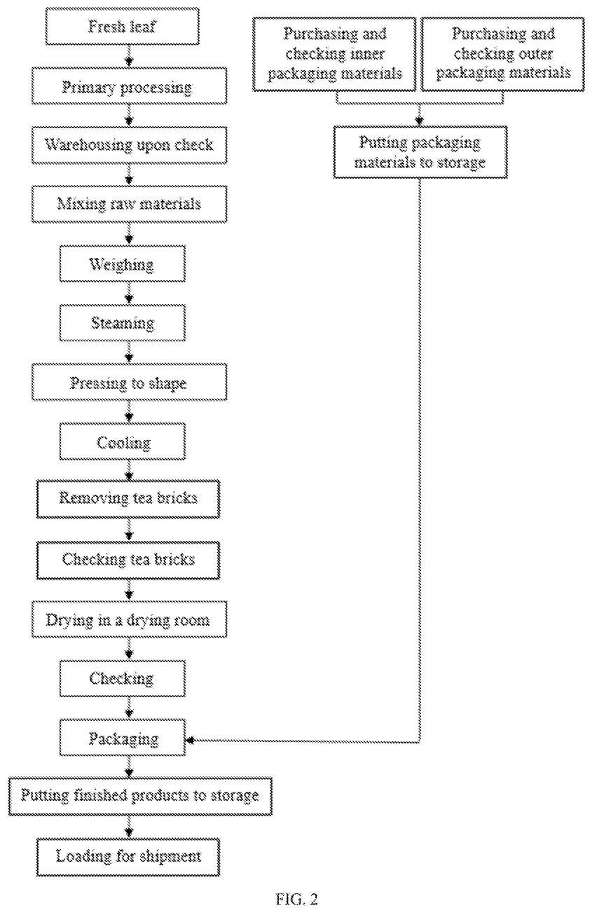

1. Flowchart (See FIG. 2)

2. Description of process

Dark primary tea leaves with better tenderness are taken as a raw material of the brick tea, and finer dried-tangerine-peel Qingzhuan tea is made by mixing and pressing third-grade dark primary tea leaves and dried tangerine peels, where a ratio of the dried tangerine peels to the Qingzhuan tea is 1:7. A process of making the dried-tangerine-peel Qingzhuan tea by pressing includes stages like steaming, pile fermentation, weighing, steaming, pressing, shaping, checking, and packaging, etc.

(1) Weighing

Raw materials are weighed accurately according to a weight of a dried-tangerine-peel green tea brick.

(2) Steaming

After the raw material tea and the dried tangerine peels are mixed uniformly, a mixture is steamed with a steamer at 98-102° C. for about 50 seconds so that the leaves absorb moisture and are softened.

(3) Molding and Pressing

A steamed mixture is pressed into a tea-brick mold, the tea-brick mold is covered with an aluminum cover plate and a corner iron fin, and the mixture is pressed compactly and shaped under a pressure machine.

(4) Cooling to Shape and Removing Tea Bricks

A pressed tea brick is cooled to shape, and a temperature of the tea brick is reduced from about 80° C. to about 50° C. in a duration of 80 minutes; the tea brick can be removed after being cooled and shaped.

(5) Drying

The removed tea bricks are fed into a drying room, and arranged orderly on a drying rack at regular intervals for drying treatment, where the drying treatment includes 5 to 7 days for drying and preferably 7 to 10 days in total, a temperature is kept at 45° C., and a relative humidity is kept at 50%; after this, a window is opened for cooling, and the tea bricks are taken out of the dry room, which is followed then by packaging.

(6) Checking and Packaging

The tea bricks that are qualified as the dried-tangerine-peel Qingzhuan tea are packaged piece by piece with trademarked packaging paper.

The beneficial effects of the present disclosure are further described below in conjunction with specific experimental data.

### Comparative Example 1

Dark primary tea leaves with better tenderness are taken as a raw material of the brick tea, and finer dried-tangerine-peel Qingzhuan tea is made by mixing and pressing third-grade dark primary tea leaves and dried tangerine peels, where a ratio of the dried tangerine peels to the Qingzhuan tea is 1:3. Other processing conditions are the same as in Example 2.

### Comparative Example 2

Dark primary tea leaves with better tenderness are taken as a raw material of the brick tea, and finer dried-tangerine-peel Qingzhuan tea is made by mixing and pressing third-grade dark primary tea leaves and dried tangerine peels, where a ratio of the dried tangerine peels to the Qingzhuan tea is 1:5. Other processing conditions were the same as in Example 2.

### Comparative Example 3

Dark primary tea leaves with better tenderness are taken as a raw material of the brick tea, and finer dried-tangerine-peel Qingzhuan tea is made by mixing and pressing third-grade dark primary tea leaves and dried tangerine peels, where a ratio of the dried tangerine peels to the Qingzhuan tea is 1:9. Other processing conditions were the same as in Example 2.

The finished dried-tangerine-peel Qingzhuan tea produced in Example 2 above is compared with the products produced in Comparative Examples 1, 2 and 3 that adopt different proportions of dried tangerine peels, and comparison results are shown in Tables 1 and 2.

Quality-indicative components (tea polyphenols, water extracts, total free amino acids, soluble sugars, theaflavins, and total flavones) of the samples of the Example and Comparative Examples are measured, and the results are shown in Table 1. The results show that the contents of water extracts, tea polyphenols, total free amino acids, and theaflavins of the sample with the ratio of 1:7 (Example 2) are significantly higher, while the contents of soluble sugars and flavones were slightly lower, than those of the sample with the ratio of 1:3 (Comparative Example 1) and the sample with the ratio of 1:5 (Comparative Example 2). The quality-indicative components of the sample with the ratio of 1:7 (Example 2) differ little from those of the sample with the ratio of 1:9 (Comparative Example 3). Therefore, the ratio of 1:7 (Example 2) is shown to be able to increase the quality-indicative components.

The sensory features (appearance, tea color, aroma, and taste) of the sample of the Example are compared with those of the Comparative Examples. As shown in Table 2, the results show that the appearance, tea color, aroma, and taste of the sample with the ratio of 1:7 (Example 2) are significantly better than the samples with the ratio of 1:3 (Comparative Example 1) and the samples with the ratio of 1:5 (Comparative Example 2). The sensory features of the sample with the ratio of 1:7 are better in that the sample has smooth and flat surfaces, regular edges and corners, a uniform thickness, and a clear impression texture, and is compact; the tea shines in a bright reddish orange color, has an aroma that combines and balance perfectly those unique to the Qingzhuan tea and dried tangerine peels, and tastes tender and sweet. The sample with the ratio of 1:7 (Example 2) differs little from the sample with a ratio of 1:9 (Comparative Example 3) in terms of appearance, but has a better reddish orange color, an aroma influenced by dried tangerine peels, and a lingering-sweet taste. Therefore, the ratio of 1:7 (Example 2) is shown to be able to enrich the taste and improve flavor.

TABLE 1
Comparison of Biochemical Quality-indicative Components of Dried-tangerine-peel
Qingzhuan Tea Samples with Different Ratios of Dried Tangerine Peels (%)

| Ratio of | | | | | | |
|---|---|---|---|---|---|---|
| dried | | | Total free | | | |
| tangerine | Water | Tea | amino | Soluble | Total | |
| peels | extracts | polyphenol | acids | sugar | flavones | Theaflavins |
| 1:3 | 22.36 | 4.32 | 1.08 | 4.46 | 4.36 | 0.27 |
| 1:5 | 25.90 | 4.44 | 1.29 | 4.39 | 4.21 | 0.32 |
| 1:7 | 29.14 | 4.86 | 1.42 | 4.27 | 4.12 | 0.44 |
| 1:9 | 30.58 | 5.95 | 1.55 | 3.98 | 3.84 | 0.44 |

TABLE 2
Comparison of Dried-tangerine-peel Qingzhuan Tea
Samples with Different Ratios of Dried Tangerine
Peels in Terms of Sensory Features (%)

| Ratio of | | | | |
|---|---|---|---|---|
| dried | | | | |
| tangerine | | Tea | | |
| peels | Appearance | color | Aroma | Taste |
| 1:3 | The tea brick has | Orange- | The mellow | Smooth |
| | relatively flat | yellow | aroma | and |
| | surfaces, and no | | of dried | relatively |
| | such infectious | | tangerine | tender |
| | microbe and | | peels is | |
| | deterioration as | | prominent, | |
| | black, white, | | and the | |
| | green, or red | | aroma of | |
| | mildew inside the | | tea leaves | |
| | brick, and is in a | | is faint | |
| | dark brown color | | | |
| 1:5 | The tea brick has | Bright | The inherent | Smooth |
| | relatively | orange- | taste | and |
| | smooth and flat | yellow | of dried | tender |
| | surfaces, | | tangerine | |
| | regular edges and | | peels | |
| | corners, a | | incorporates | |
| | relatively uniform | | the aroma | |
| | thickness, | | unique | |
| | and a slightly | | to tea leaves, | |
| | clear impression | | with a | |
| | texture, is slightly | | slightly stale | |
| | compacted, | | aroma | |
| | without such | | | |
| | infectious microbe | | | |
| | and deterioration | | | |
| | as black, white, | | | |
| | green, or red | | | |
| | mildew inside the | | | |
| | brick, and is cyan | | | |
| | and brown in color | | | |
| 1:7 | The tea brick has | Bright | The aroma | Tender |
| | smooth and flat | orange- | unique | and |
| | surfaces, regular | red | to tea leaves | sweet |
| | edges and corners, | | incorporates | |
| | a uniform thickness, | | the inherent; | |
| | and a clear | | taste of dried | |
| | impression texture, | | tangerine | |
| | is compacted, | | peels, which | |
| | without such | | is pure | |
| | infectious microbe | | | |
| | and deterioration | | | |
| | as black, white, | | | |
| | green, or red | | | |
| | mildew inside the | | | |
| | brick, and is cyan | | | |
| | and brown in color | | | |
| 1:9 | The tea brick has | Shiny | The inherent | Mellow |
| | smooth and | dark | aroma | |
| | flat surfaces, | red | unique to | |
| | regular edges and | | brick tea, | |
| | corners, a uniform | | which is pure | |
| | thickness, and a clear | | | |
| | impression texture, | | | |
| | is compacted, without | | | |
| | such infectious | | | |
| | microbe and | | | |
| | deterioration as | | | |
| | black, white, green, | | | |
| | or red mildew inside | | | |
| | the brick, and is cyan | | | |
| | and brown in color | | | |

The dried-tangerine-peel Qingzhuan tea brick prepared in this example has smooth and flat surfaces, regular edges and corners, a uniform thickness, and a clear impression texture, without such infectious microbe and deterioration as black, white, green, or red mildew inside the brick; the tea brick has an excellent and stable quality, is cyan and brown in color, has rich nutrition, and can be in storage for long. Furthermore, it is convenient to carry the product, and steps of soaking the product in water for brewing are simple and quick. In addition, the product is endurable with constant color and taste of the tea even after 10 rounds of brewing; this tea has health-care effects of protecting the gastrointestinal tract, refreshing lungs, clearing the intestines, protecting the liver, relieving hyperglycemia and hyperlipidemia, and losing weight, which renders this tea an optimal choice for those who pursue high quality and superior taste of tea.

To verify the taste and health-care efficacy of the dried-tangerine-peel Qingzhuan tea of the Example herein, the inventor selects 100 men and women aged 20 to 75 as subjects for a test, half male and half female. The main symptoms of the subjects before the test include gastrointestinal discomfort, intense mental stress due to work, obesity, smoking addiction, hypertension, hyperlipidemia, etc. The subjects are randomly divided into 4 groups, 25 people in each group; Groups 1 to 3 are the test groups, and Group 4 is the control group. The subjects in Groups 1 to 3 drank 600 mL of the dried-tangerine-peel Qingzhuan tea prepared in the Example herein every day (in brewed tea, the ratio of tea to water is 1:20, the same below). Group 4 drank 600 mL of Qingzhuan tea available from the market every day. After half a year, it is surveyed that the subjects in Groups 1 to 3 are relieved from obesity, hyperglycemia, and hyperlipidemia more effectively than those in Group 4; more than 96% of the subjects in Groups 1 to 3 are satisfied with the taste, and 100% of the subjects in Groups 1 to 3 consider that the dried-tangerine-peel Qingzhuan tea can relieve fatigue after drinking. In the subjects in Group 4, more than 30% are less satisfied with the taste, and they are mainly young people. The above results show that the dried-tangerine-peel Qingzhuan tea provided by the Example of the present disclosure has great health-care effects of protecting the gastrointestinal tract, clearing the intestines, protecting the liver, relieving hyperglycemia and hyperlipidemia, and losing weight, suitable for long-term drinking.

To verify the effects of the dried-tangerine-peel Qingzhuan tea provided by the Example herein in relieving hyperlipidemia and losing weight, the inventor selects Sprague-Dawley rats as test subjects, and the rats are randomly divided into a normal group, a model group, a positive control group, and dried-orange-peel Qingzhuan tea groups defined by high, medium and low doses of tea (in brewed tea, ratios of tea to water are 1:25, 1:50, and 1:75), with 10 rats in each group. During the test, except for the normal group, which is given distilled water and common feed, the other groups are given alcohol with different concentrations and high-sugar and high-fat feed, and the rats are free to eat and drink. Each group is administered with 25 ml of tea by gavage, 4 times a day, for 6 consecutive weeks, and blood and materials are collected at the end of the test. Triglyceride (TG), alanine aminotransferase (ALT), aspartate aminotransferase (AST), alkaline phosphatase (ALP) in serum, TG in the liver tissue and TG in feces are measured. Compared with the model group, the dried-tangerine-peel Qingzhuan tea groups can all reduce serum and liver TG levels to varying degrees, inhibit serum ALT, AST, ALP activities, and significantly reduce the free fatty acids in serum; the dried-tangerine-peel Qingzhuan tea has a significant effect of reducing TG in hyperlipidemia model rats.

The above results show that the method of the present disclosure enhances the bonding between dried tangerine peels and tea leaves; the resultant dried-tangerine-peel green tea brick has smooth and flat surfaces, regular edges and corners, a uniform thickness, and a clear impression texture, and has an improved and enriched taste of the tea; furthermore, the health-care effect and flavor of the Qingzhuan tea is improved. A product of the dried-tangerine-peel tea produced through the method herein has an excellent and stable quality, is cyan and brown in color, can be in storage for long, and can be conveniently carried: furthermore, health-care effects of protecting the gastrointestinal tract, clearing the intestines, protecting the liver, relieving hyperglycemia and hyperlipidemia, and losing weight are rendered, suitable for long-term drinking.

What is claimed is:

1. A method for processing dried-tangerine-peel Qingzhuan tea, comprising steps of:
step 1, weighing tea raw materials: weighing tea raw materials accurately according to a weight of a dried-tangerine-peel green tea brick;
step 2, steaming: mixing raw material tea leaves and dried tangerine peels evenly, and steaming a mixture with a steamer;
step 3, molding and pressing: pressing the mixture into a tea-brick mold, covering with an aluminum cover plate and a corner iron fin immediately, and pressing compactly to shape the mixture under a pressure machine;
step 4, cooling to shape and removing tea bricks: cooling to shape a pressed tea brick, and then removing the tea brick that is cooled and shaped;
step 5, drying: feeding the removed tea bricks to a drying room, arranging the tea bricks orderly on a drying rack at regular intervals for drying treatment, stopping heating after the drying treatment is finished, opening a window for cooling, taking the tea bricks out of the dry room, and then packaging; and
step 6, checking and packaging the tea bricks: packaging the tea bricks that are qualified as the dried-tangerine-peel Qingzhuan tea piece by piece with trademarked packaging paper, and putting a finished product into storage.

2. The method for processing dried-tangerine-peel Qingzhuan tea according to claim 1, wherein in step 1, dark primary tea leaves with better tenderness are taken as a raw material of the brick tea, and finer dried-tangerine-peel Qingzhuan tea is made by mixing and pressing third-grade dark primary tea leaves and dried tangerine peels, where a ratio of the dried tangerine peels to the Qingzhuan tea is 1:7.

3. The method for processing dried-tangerine-peel Qingzhuan tea according to claim 1, wherein in step 2, the raw material tea leaves are uniform and complete, scented, and refreshing, without mildew or any artificial color in appearance, any flavoring agent, any deterioration, or any peculiar smell; in terms of inherent qualities, the raw material tea leaves can be brewed to release an intense and lasting aroma; the brewed tea leaves are a even mixture of both fresh and aged ones; tea dregs show uniform glosses; the tea is clear in a yellowish green color, with few tea dregs, ash content≤9.0%, and moisture>10.0%.

4. The method for processing dried-tangerine-peel Qingzhuan tea according to claim 1, wherein in step 2, the tangerine peels are obtained through a natural sunning method, have a faint and non-pungent smell, and release a mellow aroma unique to tangerine peels;
a surface of the tangerine peels looks in dark brown, has a thin skin, and is lightweight and easy to be bent; further, the surface of dried tangerine peels has a delicate fragrance, is in an orange or reddish brown color, and is featured by fine wrinkles and depressed punctiform oil cavities; the surface is yellow-white, rough and spongy, has a yellow-white or yellow-brown vein-like vascular bundle, and is slightly hard and crisp, with an intense and bitter flavor.

5. The method for processing dried-tangerine-peel Qingzhuan tea according to claim 1, wherein in step 2, the steaming is conducted at a temperature of 98-102° C. for 50 seconds to wet and soften the tea leaves.

6. The method for processing dried-tangerine-peel Qingzhuan tea according to claim 1, wherein the cooling comprises lowering a temperature of the tea bricks from 80° C. to 50° C. in a duration of 80 minutes.

7. The method for processing dried-tangerine-peel Qingzhuan tea according to claim 1, wherein in step 5, the drying treatment comprises 5 to 7 days for drying, and preferably 7 to 10 days in total, where a temperature is kept at 45° C., and a relative humidity is kept at 50%.

8. The method for processing dried-tangerine-peel Qingzhuan tea according to claim 1, wherein in step 5, an inner packaging material meets a standard for edible products, and an outer packaging material is clean and sanitary and can be clean cartons.

9. The method for processing dried-tangerine-peel Qingzhuan tea according to claim 1, wherein in step 6, it is required that a storage environment shall be:
kept dry, ventilated, and clean, provided with facilities for preventing poison, rats and pests, equipped with ultraviolet disinfection facilities in a warehouse for inner packaging materials, so as to ensure the storage is kept in a dry, ventilated and clean environment.

10. The method for processing dried-tangerine-peel Qingzhuan tea according to claim 1, wherein it is further required for the storage environment that:
a stack shall have a thickness of more than 30 cm from a wall and a distance of not less than 15 cm from a ground, and it is not allowed to store any articles, sundries or contaminated food which may undermine food hygiene.
